(19) United States
(12) Patent Application Publication
(10) Pub. No.: US 2008/0174716 A1
(43) Pub. Date: Jul. 24, 2008

(54) Transreflective type LCD panel and LCD device using the same

(75) Inventors: Chien-Chung Chen, Taichung (TW); Chien-Chung Kuo, Taichung (TW)

Correspondence Address: BACON & THOMAS, PLLC, 625 SLATERS LANE, FOURTH FLOOR, ALEXANDRIA, VA, 22314, US

(73) Assignee: Wintek Corporration, TAICHUNG (TW)

(21) Appl. No.: 12/007,730

(22) Filed: Jan. 15, 2008

(30) Foreign Application Priority Data
Jan. 24, 2007 (TW) 96102730

(51) Int. Cl. G02F 1/1333

(52) U.S. Cl. 349/61; 349/104; 349/155; 349/113

(57) ABSTRACT

A transreflective type liquid crystal display (LCD) panel and an LCD device using the same are provided. The transreflective type LCD panel includes a first substrate and a second substrate, wherein a liquid crystal layer is sealed between the two substrates. The second substrate includes a filter structure having several optical filters for allowing the lights of at least three colors in a light source to pass through the filter structure. Each of the optical filters has at least two reflective layers and one spacer layer disposed between the reflective layers. When a light source unit is driven to provide the light to the first substrate or the second substrate, the lights of the three colors in the light source pass through the optical filters of corresponding colors respectively. The light source unit is, for example, the backlight module of an LCD device or an external light source.

This application claims the benefit of Taiwan application Serial No. 96102730, filed Jan. 24, 2007, the subject matter of which is incorporated herein by reference.

### BACKGROUND OF THE INVENTION

1. Field of the Invention

The invention relates in general to a transreflective type LCD panel and an LCD device using the same, and more particularly to a transreflective type LCD panel with high transmission and high utilization of backlight and an LCD device using the same.

2. Description of the Related Art

Normally, a transreflective type LCD mainly makes use of two technologies to generate the transreflective effect. One of the technologies employs a transreflective plate, and the other divides a pixel into a transmissive area and a reflective area.

Referring to FIG. 1, a cross-sectional view of a conventional transreflective type LCD panel with a transreflective plate is shown. As indicated in the conventional transreflective type LCD panel 1 of FIG. 1, a color filter 12 is disposed on a first substrate 11, a transreflective plate 14 is disposed on a second substrate 13, and a backlight source unit (not shown) is disposed on one side of the second substrate 13. The color filter 12 includes a red filter layer 121, a green filter layer 122 and a blue filter layer 123. When the backlight source unit is turned on, the light L of the backlight source unit will pass through the transreflective plate 14 disposed on the second substrate 13 and the color filter 12 disposed on the first substrate 11 to display the colors. In order to become transreflective, the transreflective plate 14 normally does not have high transmission rate, hence resulting in a low light utilization of the backlight source unit. Similarly, when the backlight source unit is turned off, the light utilization of external light L is also not good enough.

Referring to FIG. 2, a cross-sectional view of a conventional transreflective type LCD panel with a transmissive area and a reflective area is shown. As indicated in the conventional transreflective type LCD panel 2 of FIG. 2, a color filter 22 is disposed on a first substrate 21. The color filter 12 includes a red filter layer 221, a green filter layer 222 and a blue filter layer 223. Several reflective plates 24 are disposed on a second substrate 23. Each reflective plate 24 corresponds to one pixel structure of the transreflective type LCD panel 2. The reflective plates 24 occupy almost half the area of each pixel structure. In transmissive mode, the light L of the backlight source unit will penetrate a portion of the pixel structure not covered by the reflective plate so as to display an image. In reflective mode, the external light L′passes through the first substrate 21 and is reflected by the reflective plate 24 disposed on the second substrate 23 so as to display an image. However, the reflective plate 24 decreases the aperture ratio of each pixel structure, as well as the display effect.

The LCD device using the transreflective type LCD panel 1 or 2 has poor color performance because the color filters 12 and 22 in FIGS. 1-2 are usually coated by pigments. Due to the light-absorption property of the pigments, the utilization of the light is easily deteriorated. To generate satisfactory luminance of the LCD device requested by the users, the backlight module of the LCD device needs more driving power. As a result, the LCD device consumes more power.

### SUMMARY OF THE INVENTION

The invention is directed to a transreflective type LCD panel and an LCD device using the same. A filter structure having several optical filters for filtering the light source is disposed on a substrate of the LCD panel. The filter structure allows the visible lights of particular wavelengths to pass through or to be reflected. Each of the optical filters includes two reflective layers and one spacer layer. Through appropriate design regarding the material and the thickness of the reflective layers and the spacer layer of the optical filters, the optical filters are capable of controlling the frequency spectrum of transmission of visible lights and displaying chromatic colors. The optical filters have excellent utilization and transmission of the light. In addition, as the backlight reflected from the LCD panel is again reflected and used by the backlight module of the LCD device, the utilization of the backlight is further increased.

According to a first aspect of the present invention, a transreflective type LCD panel is provided. The transreflective type LCD panel includes a first substrate and a second substrate. A liquid crystal layer is sealed between the first and the second substrates. The second substrate includes a filter structure that has several optical filters for permitting the lights of at least three colors in a light source to pass through the filter structure. Each of the optical filters has at least two reflective layers and one spacer layer disposed between the reflective layers.

According to a second aspect of the present invention, an LCD device is provided. The LCD device includes a transreflective type LCD panel and a backlight module, wherein the backlight module is disposed on one side of the transreflective type LCD panel. The transreflective type LCD panel includes a first substrate and a second substrate. A liquid crystal layer is sealed between the first substrate and the second substrate. The second substrate includes a filter structure that has several optical filters for permitting the lights of at least three colors in a light source to pass through the filter structure. Each of the optical filters includes at least two reflective layers and one spacer layer disposed between the reflective layers.

The invention will become apparent from the following detailed description of the preferred but non-limiting embodiments. The following description is made with reference to the accompanying drawings.

### BRIEF DESCRIPTION OF THE DRAWINGS

FIG. 1 is a cross-sectional view of a conventional transreflective type LCD panel with a transreflective plate;

FIG. 2 is a cross-sectional view of a conventional transreflective type LCD panel with a transmissive area and a reflective area;

FIG. 3 is a cross-sectional view of a transreflective type LCD panel according to a preferred embodiment of the invention;

FIG. 4 is a cross-sectional view of a filter structure in FIG. 3;

FIGS. 5A to 5C are spectrum diagrams of transmissive lights of the optical filters of FIG. 4;

FIGS. 6A to 6C are spectrum diagrams of reflected lights of the optical filters of FIG. 4;

FIG. 7A is a cross-sectional view of the LCD device in reflective mode;

FIG. 7B is a cross-sectional view of the LCD device of FIG. 7A in transmissive mode; and

FIG. 8 is a cross-sectional view showing the light path between the LCD panel and the backlight module of FIG. 7B.

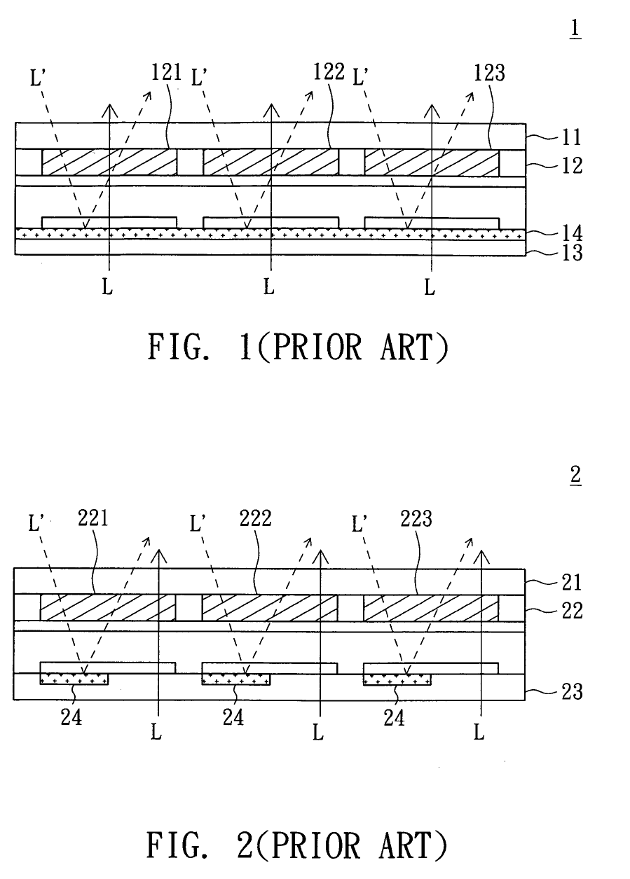

### DETAILED DESCRIPTION OF THE INVENTION

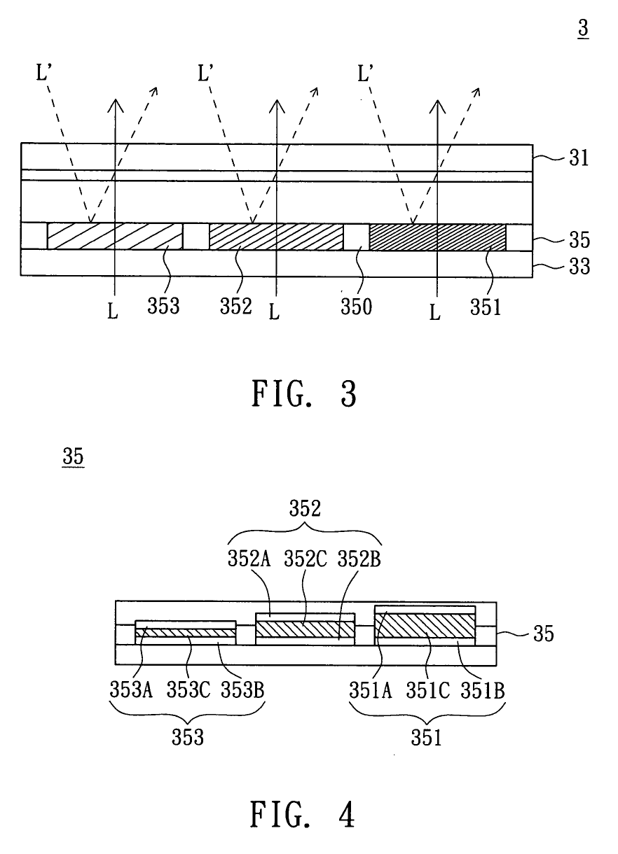

Referring to FIG. 3, a cross-sectional view of a transreflective type LCD panel according to a preferred embodiment of the invention is shown. As indicated in FIG. 3, the transreflective type LCD panel 3 includes a first substrate 31 and a second substrate 33 parallel to the first substrate 31, wherein a liquid crystal layer (not illustrated) is sealed between the first substrate 31 and the second substrate 33. The second substrate 33 includes a filter structure 35 that has several optical filters 351 to 353. Each of the optical filters 351 to 353 has at least two reflective layers and one spacer layer disposed between the reflective layers (shown in FIG. 4).

By appropriate design, different colors are displayed when the light source passes through the optical filters 351 to 353. As indicated in FIG. 3, the filter structure 35 includes a black matrix 350 for separating the optical filters 351 to 353. The optical filter 351 is capable of displaying red color, the optical filter 352 is capable of displaying green color and the optical filter 353 is capable of displaying blue color, for example. In the LCD panel 3, each of the optical filters 351 to 353 corresponds to a pixel structure.

Referring to FIG. 4, a cross-sectional view of a filter structure in FIG. 3 I shown. As indicated in FIG. 4, each of the optical filters 351 to 353 includes two reflective layers and one spacer layer. By selecting the structure, the material and the thickness of the optical filters 351 to 353, different frequency spectrums of transmission are generated when the light source passes through the optical filters 351 to 353. In this embodiment, all reflective layers of the optical filters 351 to 353 are made of the same material, and their thickness are the same, for example. The optical filter 351 has two reflective layers 351A and 351B, the optical filter 352 has two reflective layers 352A and 352B, and the optical filter 353 has two reflective layers 353A and 353B. The optical filters 351 to 353 differ from each other in the spacer layers 351C to 353C so as to display different colors. Preferably, the thickness of each of the reflective layers ranges from 5 nm to 60 nm, and the thickness of each of the spacer layers ranges from 1 nm to 900 nm. As to the materials of the reflective layers and the spacer layers, the reflective layers are made of silver (Ag) or silver alloy, and each of the spacer layer is, for example, a dielectric layer or a conductive metal oxide layer. The dielectric layer is made of magnesium fluoride (MgF2), silicon dioxide (SiO2), aluminum oxide (Al2O3), titanium dioxide (TiO2), zirconium dioxide (ZrO2), or niobium oxide (Nb2O5). The conductive metal oxide layer is made of indium tin oxide (ITO), indium zinc oxide (IZO) or aluminum zinc oxide (AZO).

TABLE 1

| Film-layer structure | Material | Thickness (nm) |
|---|---|---|
| All reflective layers | Silver | 5~60 |
| Spacer layer 351C | Silicon Dioxide | 150-200 |
| Spacer layer 352C | Silicon Dioxide | 110-160 |
| Spacer layer 353C | Silicon Dioxide | 70-110 |

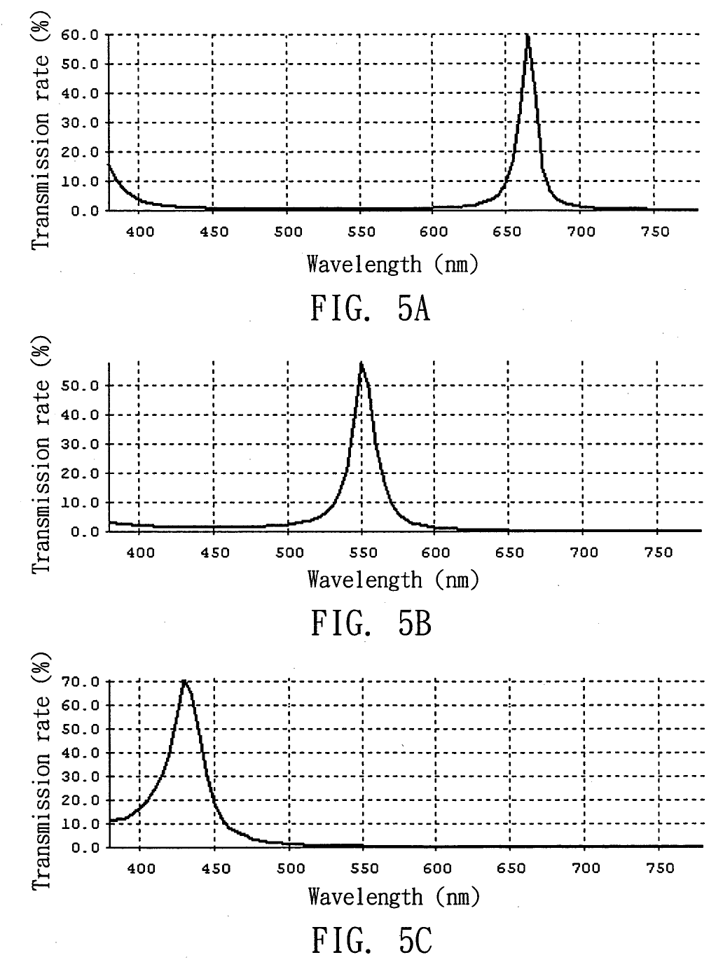

The light transmission and reflection of the optical filters 351 to 353 are exemplified below. Referring to Table 1 and FIGS. 5A to 5C, FIGS. 5A to 5C are spectrum diagrams of transmissive lights of the optical filters of FIG. 4, Table 1 states the materials and the thickness of each film layers of the optical filters 351 to 353. Among visible lights, the wavelength of the red light is approximately 650 nm, the wavelength of the green light is approximately 546.1 nm, and the wavelength of the blue light is approximately 450 nm. In the present embodiment of the invention, a white light is projected onto the filter structure 13. The transmission rates of the visible lights of different wavelengths are measured after the visible lights pass through the optical filters 351 to 353.

As indicated in FIG. 5A, when the thickness of the spacer layer 351C ranges from 150 nm to 200 nm, the visible light whose wavelength ranges from 650 nm to 670 nm has a maximum transmission rate. Therefore, the visible light approximates to a red light, such that the optical filter 351 is capable of displaying red color. As indicated in FIG. 5B, when the thickness of the spacer layer 352C ranges from 110 nm to 160 nm, the visible light whose wavelength is approximately 550 nm has a maximum transmission rate. Therefore, the visible light approximates to a green light, such that the optical filter 352 is capable of displaying green color. As indicated in FIG. 5C, when the thickness of the spacer layer 353C ranges from 70 nm toll 0 nm, the visible light whose wavelength ranges from 420 nm to 440 nm has a maximum transmission rate. Therefore, the visible light approximates to a blue light, such that the optical filter 353 is capable of displaying blue color. As the spectrums of transmission of the optical filters 351 to 353 have narrower bandwidths of frequency, the color purities are higher and the display effects are better.

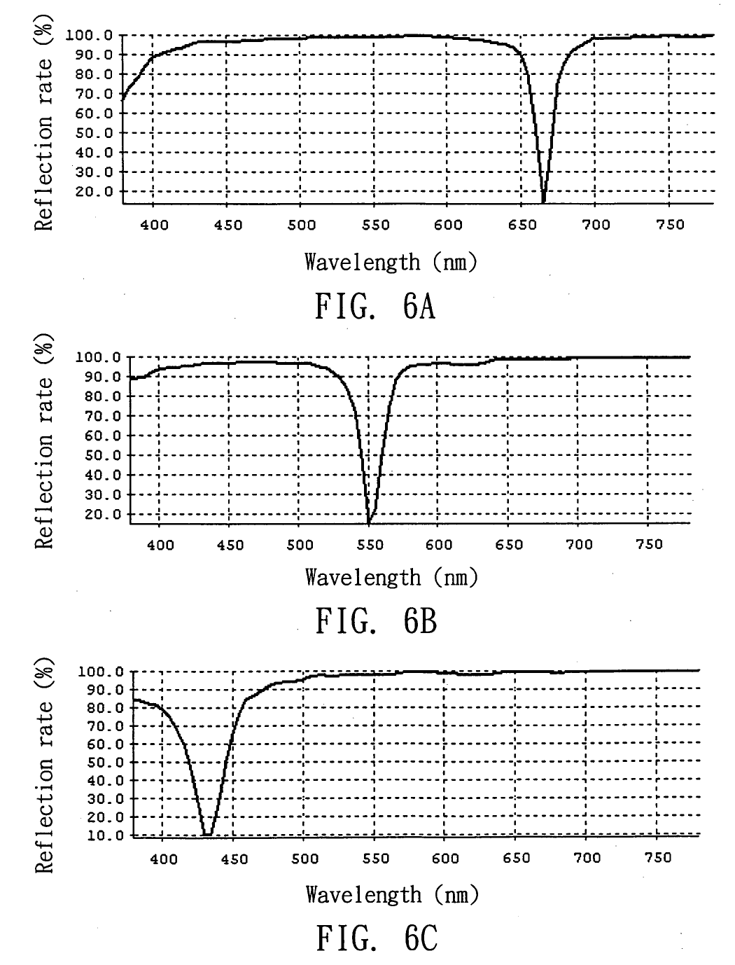

Referring to FIGS. 6A to 6C, spectrum diagrams of reflected lights of the optical filters of FIG. 4 are shown. As indicated in FIG. 6A, the optical filter 351 allows the visible light (approximate to a red light) whose wavelength ranges from 650 nm to 670 nm to pass through. The light reflected by the optical filter 351 is a mixed light (such as a cyan light) of the green light and the blue light. Similarly, as indicated in FIG. 6B, the optical filter 352 allows the visible light (approximate to the green light) whose wavelength approximates 550 nm to pass through. The light reflected by the optical filter 352 is a mixed light (such as a purple light) of the red light and the blue light. As indicated in FIG. 6C, the optical filter 353 allows the visible light (approximate to the blue light) whose wavelength ranges from 420 nm to 440 nm to pass through. The light reflected by the optical filter 353 is a mixed light (such as a yellow light) of the red light and the green light.

If the light is projected onto one side of the filter structure 35, the different colors of the visible lights corresponding to the optical filters 351 to 353 are displayed on the other side of the filter structure 35. As the mixed lights formed by the lights reflected from the optical filters 351 to 353 are mixed again, a monochromatic light approximate to the white light can be generated on the incident side of the filter structure 35.

In addition to the above three colors (red, green, blue), the optical filters are also capable of displaying other colors such as yellow, cyan or purple by means of changing the materials and the thickness of the reflective layers and the spacer layers. Furthermore, the optical filters are also able to display more than three colors.

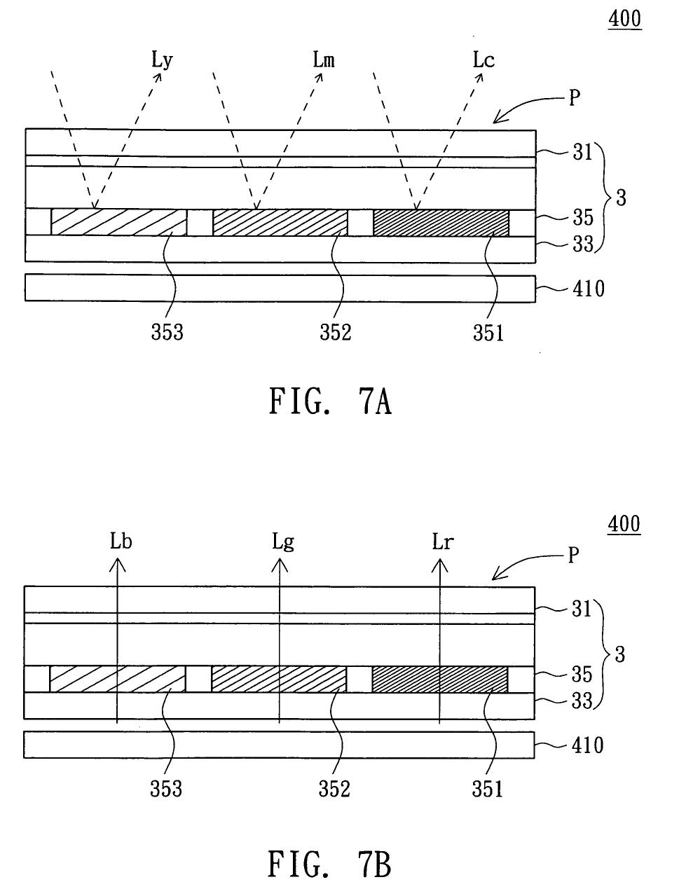

The transreflective type LCD panel 1 in the present embodiment of the invention is normally used in a LCD device with a backlight module. Referring to FIGS. 7A to 7B, FIG. 7A is a cross-sectional view of the LCD device in reflective mode, and FIG. 7B is a cross-sectional view of the LCD device of FIG. 7A in transmissive mode. The backlight module 410 of the LCD device 400 is disposed on one side of the second substrate 33 of the transreflective type LCD panel 3. A display pixel P is formed by three sub-pixel structures corresponding to the three optical filters 351 to 353. As indicated in FIG. 7A, in the reflective mode, the backlight module 410 is turned off. When the backlight module 410 is turned off, the light for the LCD panel 3 to display is provided by an external light source (not shown). The optical filters 351 to 353 can have the light transmitted or reflected. After the light from the external light source reaches the second substrate 33 from the first substrate 31 side, the optical filters 351 to 353 will allow the corresponding visible lights to pass through but reflect others visible lights. For example, the cyan light Lc is reflected from the optical filter 351, the purple light Lm is reflected from the optical filter 352, and the yellow light Ly is reflected from the optical filter 353. By mixing the three visible lights, Lc, Lm, and Ly, a monochromatic image approximate to a black/white image is displayed in the reflective mode.

In the transmissive mode (normal mode), as indicated in FIG. 7B, the light is provided by the backlight module 410 disposed on the one side of the second substrate 33. When the light is projected onto the LCD panel 3, the red light Lr, the green light Lg and the blue light Lb respectively pass through the optical filters 351 to 353. By controlling the inclination of the liquid crystal cells, the concentrations of the red color, the green color, and the blue color in each pixel P are adjusted, so as to display a chromatic image.

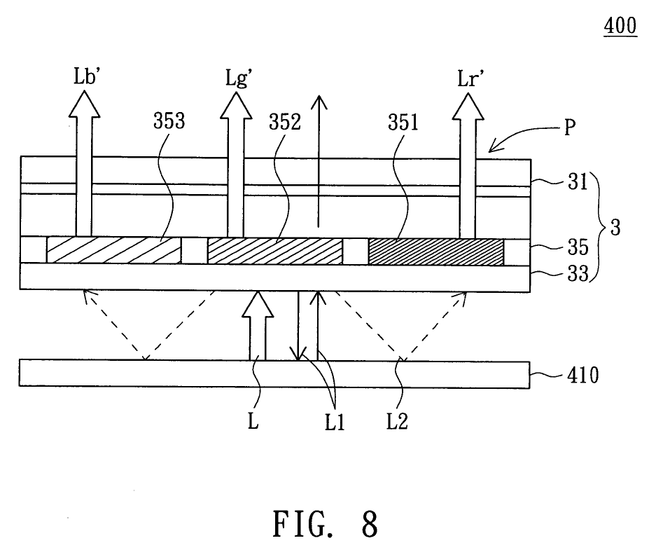

Referring to FIG. 8 for a detailed elaboration of the present embodiment of the invention, FIG. 8 is a cross-sectional view showing the light path between the LCD panel and the backlight module of FIG. 7B. The present embodiment of the invention is exemplified by the backlight passing through the optical filter 352. As indicated in FIG. 8, when the backlight L is projected onto the LCD panel 3, the green light Lg (refer to FIG. 7B) and a reflected light are generated. The green light Lg passes through the optical filter 352 but others visible lights are reflected by the optical filter 352 to form the reflected light. After the reflected light is reflected from the backlight module 410 again, the reflected light is divided into two lights along two different paths. The reflected lights L1, L2 along two paths are taken for example. The reflected light L1 along the first path will pass through the same optical filter 352. The reflected light L2 along the second path will pass through the optical filters 351 and 353 located on the two sides of the optical filter 352.

The reflected light L1 or L2 are the combination of the red light, the blue light and a part of the green light. The green light will pass through the optical filter 352 again when the reflected light L1 is directed along the first path. Therefore, the green light will be enhanced. The utilization rate of the red light and the blue light is also largely increased when the reflected light L2 is directed along the second path. Similarly, when the light passes through other optical filters such as optical filters 351 and 353 of the filter structure 35, the same effect is generated.

With the reflective effect of the backlight module 210, an enhanced red light Lr′, a green light Lg′ and a blue light Lb′ are generated. As the LCD panel 3 has higher resolution, each pixel of the LCD panel 3 is smaller. Therefore, the gaps between the optical filters 351 to 353 are decreased, such that the reflected light L2 along the second path has higher utilization rate of light.

According to the transreflective type LCD panel and the LCD device using the same disclosed in the above embodiment of the invention, a filter structure having several optical filters for filtering the light source is disposed on a substrate of the LCD panel. The filter structure reflects the light or allows the light to pass through. By appropriate selection of the materials and the thickness of the reflective layers and spacer layers of the optical filters, the optical filters are capable of allowing visible lights of particular bandwidth of frequency to pass through so that particular colors are displayed. Due to the optical filters that have excellent transmission, the LCD panel has high color purity. The backlight module of the LCD device is disposed on one side of the substrate that has the filter structure. Moreover, when the backlight is reflected in the backlight module and further provided to other pixels of the LCD panel, the backlight has good utilization and helps to reduce energy loss.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transreflective type liquid crystal display (LCD) panel, comprising:
a first substrate; and
a second substrate, wherein a liquid crystal layer is sealed between the second substrate and the first substrate, the second substrate includes a filter structure that has a plurality of optical filters for permitting the lights of at least three colors in a light source to pass through the filter structure, and each of the optical filters has at least two reflective layers and one spacer layer disposed between the two reflective layers.

2. The LCD panel according to claim 1, wherein the first substrate and the second substrate comprises a plurality of sub-pixel structures, and each of the optical filters corresponds to one of the sub-pixel structures.

3. The LCD panel according to claim 1, wherein the two reflective layers are made of silver or silver alloy.

4. The LCD panel according to claim 1, wherein the spacer layer is a dielectric layer or a conductive metal oxide layer.

5. The LCD panel according to claim 4, wherein the dielectric layer is made of magnesium fluoride (MgF2), silicon dioxide (SiO2), aluminum oxide (Al2O3), titanium dioxide (TiO2), zirconium dioxide (ZrO2) or niobium oxide (Nb2O5).

6. The LCD panel according to claim 4, wherein the conductive metal oxide layer is made of indium tin oxide (ITO), indium zinc oxide (IZO) or aluminum zinc oxide (AZO).

7. The LCD panel according to claim 1, wherein the thickness of each of the two reflective layers ranges from 5 nm to 60 nm.

8. The LCD panel according to claim 1, wherein the thickness of the spacer layer ranges from 1 nm to 900 nm.

9. A liquid crystal display (LCD) device, comprising:
a transreflective type LCD panel, comprising:
a first substrate; and
a second substrate, wherein a liquid crystal layer is sealed between the first substrate and the second substrate, the second substrate includes a filter structure that has a plurality of optical filters for permitting the lights of at least three colors in a light source to pass through the filter structure, and each of the optical filters has at least two reflective layers and one spacer layer disposed between the two reflective layers; and
a backlight module disposed on one side of the transreflective type LCD panel;
wherein, when the backlight module is turned on, the lights of the three colors in the light source respectively pass through the optical filters of corresponding colors.

10. The LCD device according to claim 9, wherein the first substrate and the second substrate comprises a plurality of sub-pixel structures, and each of the optical filters corresponds to one of the sub-pixel structures.

11. The LCD device according to claim 9, wherein the backlight module is disposed on one side of the second substrate.

12. The LCD device according to claim 9, wherein the two reflective layers are made of silver or silver alloy.

13. The LCD device according to claim 9, wherein the spacer layer is a dielectric layer or a conductive metal oxide layer.

14. The LCD device according to claim 13, wherein the dielectric layer is made of magnesium fluoride (MgF2), silicon dioxide (SiO2), aluminum oxide (Al2O3), titanium dioxide (TiO2), zirconium dioxide (ZrO2) or niobium oxide (Nb2O5).

15. The LCD device according to claim 13, wherein the conductive metal oxide layer is made of indium tin oxide (ITO), indium zinc oxide (IZO) or aluminum zinc oxide (AZO).

16. The LCD panel according to claim 9, wherein the thickness of each of the two reflective layers ranges from 5 nm to 60 nm.

17. The LCD panel according to claim 9, wherein the thickness of the spacer layer ranges from 1 nm to 900 nm.
